(19) United States
(12) Patent Application Publication
(10) Pub. No.: US 2010/0158774 A1
(43) Pub. Date: Jun. 24, 2010

(54) TEXTURED PARTICULATE FILTER FOR CATALYTIC APPLICATIONS

(75) Inventors: Patricia Andy, Les Taillades (FR); Caroline Tardivat, Aix-En-Provence (FR); Ahmed Marouf, Cavaillon (FR); Damien Mey, Cavaillon (FR); Catherine Jacquiod, Gif Sur Yvette (FR); Valerie Goletto, Paris (FR); Alexandra Dekoninck, Ezanville (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN CENTRE DE RECHERCHES ET D'ET EUROPEEN, Courbevoie (FR)

(21) Appl. No.: 12/600,661

(22) PCT Filed: May 19, 2008
(86) PCT No.: PCT/FR2008/050855

§ 371 Date: Jan. 15, 2010

(30) Foreign Application Priority Data
May 23, 2007 (FR) 0755217

(51) Int. Cl. B01D 53/94; B32B 3/12; C04B 35/624; F01N 3/022; F01N 3/035

(52) U.S. Cl. 423/213.2; 422/180; 428/312.2; 264/630; 264/621

(57) ABSTRACT

Catalytic filter comprising a porous matrix consisting of an inorganic material, in the form of grains that are interconnected so as to provide cavities between them, such that the open porosity is between 30 and 60% and the median pore diameter is between 5 and 40 μm, said filter being characterized in that the grains and possibly the grain boundaries of the inorganic material are covered over at least part of their surface with a texturizing material, said texturizing consisting of irregularities having dimensions of between 10 nm and 5 microns and in that a catalytic coating at least partially coats the texturizing material and optionally, at least partially, the grains of the inorganic material.

The present invention relates to the field of porous filtering materials. More particularly, the invention relates to typically honeycomb structures that can be used for filtering solid particles contained in exhaust gases of a diesel or gasoline engine and additionally incorporating a catalytic component enabling, for example jointly, polluting gases of the NOₓ, carbon monoxide CO or unburnt hydrocarbon HC type to be eliminated.

The filters according to the invention have a matrix of an inorganic, preferably ceramic, material chosen for its capability of constituting a structure with porous walls and for acceptable thermomechanical strength for application as a particulate filter in an automobile exhaust line. Such a material is typically based on silicon carbide, in particular recrystallized silicon carbide. Other oxide, carbide or nitride materials, such as matrices based for example on cordierite, also fall within the scope of the present invention, even though SiC-based materials are preferred because of their high refractoriness and their high chemical inertness.

The increase in porosity and in particular the mean pore size is in general desirable for applications for the catalytic filtration treatment of gases. This is because such an increase makes it possible to limit the pressure drop resulting from a particulate filter as described above being positioned in an automobile exhaust line. The term “pressure drop” is understood to mean the pressure difference of the gases that exist between the inlet and the outlet of the filter. However, this increase in porosity is limited by the associated reduction in the thermomechanical strength properties of the filter, especially when the latter is subjected to successive soot particulate accumulation phases and regeneration phases, i.e. phases in which the soot is eliminated by burning them within the filter. During these regeneration phases, the filter may be at mean inlet temperatures of around 600 to 700° C., while local temperatures of more than 1000° C. may be reached. These hot spots constitute so many flaws that are capable over the lifetime of the filter of impairing its performance or even of deactivating it. With very high degrees of porosity, for example greater than 60%, it has in particular been found on silicon carbide filters that the thermomechanical strength properties are greatly reduced.

This conflict between the pressure drop undergone by a filter and its thermomechanical strength becomes all the more acute if it is desired to combine the particulate filtration function with an additional component for eliminating or treating the polluting gaseous phases contained in the exhaust gases, of the NOₓ, CO or HC type. Although effective catalysts for treating these pollutants are at the present time very well known, their incorporation into particulate filters clearly poses the problem, on the one hand, of their effectiveness when they are present in the pores of the inorganic matrix constituting the filter and, on the other hand, of their additional contribution to the pressure drop associated with the filter incorporated into an exhaust line.

With the aim of improving the efficiency of the catalytic treatment of the gaseous pollutants, the solution currently most studied consists in increasing the amount of catalytic solution deposited per volume of filter, typically by impregnation.

Therefore, to keep the pressure drop at acceptable values for an application in an automobile exhaust line, a necessary trend in these structures is toward the highest porosity. As explained above, such a trend is very rapidly limited as it inevitably causes too great a drop in the thermomechanical properties of the filter for such an application.

Furthermore, other problems arise because of this increase in catalyst loading. The greater thickness of the catalyst layer substantially increases the local hot spot problems already mentioned, especially during the regeneration phases owing to the poor capability of current catalytic compositions to transfer the soot combustion heat to the inorganic matrix.

Finally, the larger thickness of the catalyst coating may lead to a lower catalytic efficiency, as mentioned in US 2007/0049492, paragraph [005], which may result in a poor distribution of the active sites, i.e. sites where the catalyzed reaction takes place, making them less accessible to the gases to be treated. This has an important impact on the light-off temperature of the catalytic reaction and consequently on the activation time of the catalyzed filter, i.e. the time needed for the cold filter to reach a temperature allowing efficient treatment of the pollutants.

In addition, this trend toward a higher loading of catalyst in filters results in evermore concentrated coating suspensions, causing productivity problems, the coating then being deposited in several impregnation cycles. Feasibility problems also arise because of the high viscosity of these suspensions. This is because above a certain viscosity dependent on the chemical nature of the catalyst solution used for the impregnation, it no longer becomes possible with conventional production means to impregnate the porous substrate efficiently.

In addition to the abovementioned difficulties, associated in particular with the increase in pressure drop, the incorporation of a catalytic component into a particulate filter also poses the following problems:
adhesion of the impregnation solution to the porous substrate must be as uniform and homogeneous as possible, but also must allow a large amount of catalytic solution to be fixed. This problem is all the more critical on matrices that take the form of interconnected grains and have a relatively smooth and/or convex surface, especially SiC-based matrices; and
to alleviate the catalyst aging problem, in particular in the sense described in application EP 1 669 580 A1, the catalytic coating deposited in the pores of the walls of the filter must be sufficiently stable over time, that is to say the catalytic activity must remain acceptable over the entire lifetime of the filter, to meet the current and future pollution-control standards.

At the present time, to guarantee acceptable catalytic performance over the entire lifetime of the filter, the solution adopted is to impregnate a larger amount of catalytic solution, and therefore of noble metals, so as to compensate for the loss of catalytic activity over time, as described in application JP 2006/341201. This solution not only results in an increase in the pressure drop, as mentioned above, but also in the cost of the process, because of the necessarily greater use of noble metals. The problem therefore still remains at the present time of how to limit the aging of the catalyst in order to ensure performance stability.

The objective of the present invention is to provide an improved solution to all the abovementioned problems.

More particularly, one of the objects of the present invention is to provide a porous filter suitable for an application as particulate filter in an automobile exhaust line, which is subjected to successive soot accumulation and combustion phases, and having a catalytic component of higher efficiency.

More particularly, for the same porosity, the catalytic filters according to the invention may have a catalytic charge substantially greater than in the current filters. According to another possible embodiment, the catalytic filters according to the invention may have better homogeneity, i.e. more uniform distribution of the catalytic charge in the porous matrix.

Such an increase in and/or the better homogeneity of the catalytic charge enable/enables in particular the efficiency of the pollutant gas treatment to be substantially improved without concomitantly increasing the pressure drop caused by the filter.

The invention thus makes it possible in particular to obtain porous structures having acceptable thermomechanical properties for the application and a substantially improved catalytic efficiency over the entire lifetime of the filter.

Another object of the present invention is to obtain catalyzed filters having better aging resistance, within the meaning described above.

More precisely, the invention relates to a catalytic filter for the treatment of solid particles and gaseous pollutants coming from the combustion gases of an internal combustion engine, comprising a porous matrix consisting of an inorganic material, in the form of grains that are interconnected so as to provide cavities between them, such that the open porosity is between 30 and 60% and the median pore diameter is between 5 and 40 μm, said filter being characterized in that:
the grains and possibly the grain boundaries of the inorganic material are covered over at least part of their surface with a texturizing material, said texturizing consisting of irregularities having dimensions of between 10 nm and 5 microns; and
a catalytic coating at least partially coats the texturizing material and optionally, at least partially, the grains of the inorganic material.

For example, said irregularities take for example the form of beads, crystallites, polycrystalline clusters, or even rods or acicular structures, hollows or craters, said irregularities having a mean diameter d of between about 10 nm and about 5 microns and a mean height h or a mean depth p of between about 10 nm and about 5 microns.

The term “mean diameter d” is understood within the meaning of the present description to be the mean diameter of the irregularities, these being individually defined from the plane tangential to the surface of the grain or of the grain boundary on which they are located.

The term “mean height h” is understood within the meaning of the present description to be the mean distance between the top of the relief formed by the texturizing and the aforementioned plane.

The term “mean depth p” is understood within the meaning of the present description to be the mean distance between, on the one hand, the deepest point formed by the impression, for example the hollow or crater of the texturizing, and, on the other hand, the aforementioned plane.

According to one possible embodiment, the mean diameter d of the irregularities is between 100 nm and 2.5 microns.

For example, the mean height h or the mean depth p of the irregularities is between 100 nm and 2.5 microns.

According to a preferred embodiment, the texturizing material covers at least 10% of the total surface of the grains and optionally of the grain boundaries of the inorganic material constituting the porous matrix. Preferably, the texturizing material covers at least 15% of the total surface of the grains and optionally of the grain boundaries of the inorganic material constituting the porous matrix.

Typically, the mean equivalent diameter d and/or the mean height h or the mean depth p of the irregularities are/is smaller than the mean size of the grains of the inorganic material constituting the matrix by a factor of between ½ and 1/1000.

For example, the mean equivalent diameter d and/or the mean height h or the mean depth p of the irregularities are/is smaller than the mean size of the grains of the inorganic material constituting the matrix by a factor of between ⅕ and 1/100.

According to one possible embodiment, the texturizing material is of the same nature as the inorganic material constituting the matrix.

According to a first embodiment, the irregularities are formed by crystallites or by a cluster of crystallites of a fired or sintered material on the surface of the grains of the porous matrix.

According to another embodiment, the irregularities essentially consist of alumina or silica beads.

Alternatively, the irregularities may also take the form of craters hollowed out in a material such as silica or alumina, said material being fired or sintered on the surface of the grains of the porous matrix.

According to a preferred embodiment, the material constituting the matrix is formed by or comprises silicon carbide.

The invention also relates to the intermediate structure for obtaining a catalytic filter for the treatment of solid particles and gaseous pollutants as claimed in one of the preceding claims and comprising a porous matrix consisting of an inorganic material, in the form of grains that are interconnected so as to provide cavities between them, such that the open porosity is between 30 and 60% and the median pore diameter is between 5 and 40 μm, said grains of the inorganic material being covered over at least part of their surface with a texturizing material as claimed in one of the preceding claims.

The invention also relates to a process for obtaining a filter as described above and comprising the following steps:
forming and firing of a honeycomb structure consisting of a porous matrix of an inorganic material, in the form of grains that are interconnected so as to provide cavities between them, such that the open porosity is between 30 and 60% and the median pore diameter is between 5 and 40 μm;
deposition, on the surface of at least some of the grains of the honeycomb structure, of a texturizing material having for example the form of beads, crystallites, polycrystalline clusters, hollows or craters; and
impregnation of the textured honeycomb structure with a solution comprising a catalyst or a catalyst precursor.

According to the process, the texturizing material is deposited by the application of a slip of said material for covering the surface of the grains, followed by a firing or sintering heat treatment, by the application of a sol-gel solution that includes a filler in the form of inorganic beads or particles, followed by a firing or sintering heat treatment or else by the application of a sol-gel solution that includes a filler in the form of organic beads or particles, followed by a firing or sintering heat treatment.

The above sol-gel solution is for example a silica sol.

More precisely, the texturizing process according to the invention is obtained either:
1) by deposition of a suspension, such as for example a slip consisting of a powder and a powder mixture preferably in a liquid such as water, or a sol-gel filled with mineral particles, or an organic or organomineral sol-gel, leading after a heat treatment to a material of crystalline and/or glassy inorganic nature, preferably of ceramic and with a thermal stability at least equal to that of alumina, which is the principal constituent of the washcoat. The deposition is followed by one or more heat treatments of the substrate, preferably in air but possibly in a controlled atmosphere, for example in argon or nitrogen, if this is necessary in particular to prevent deterioration or oxidation of the substrate or of the coating for example. It may also be envisioned to carry out this texturizing on the green or partially fired substrate provided that the mechanical strength and integrity of the substrate are sufficient for the texturizing operation to be carried out and provided that the firing conditions enable the aforementioned texturizing characteristics to be obtained. In the case of suspensions, in addition to the powder(s) of inorganic (preferably ceramic) nature or their precursors, for example an organometallic compound (for example a silicon alkoxide, such as TEOS and liquid), the formulation may contain additions taken from the following list: one or more dispersants (for example, an acrylic resin or an amine derivative); a binder of organic nature (for example an acrylic resin or a cellulose derivative) or even of mineral nature (for example clay); a wetting or film-forming agent (for example, a polyvinyl alcohol PVA); and one or more pore formers (for example polymers, latices, polymethyl methacrylate), some of these components possibly combining several of these functions. Just like the form and the particle size of the powders or precursors and the nature of the suspension liquid, the nature and the amount of these additions have an impact on the size of the microtexturizing and its location on the substrate. The preferred texturizing must be on the surface of the grains but also partly on the grain boundaries;
2) or by starting from a powder or a powder mixture via a carrier gas. Direct deposition starting from liquid or gaseous species, for example by PVD (physical vapor deposition) or CVD (chemical vapor deposition), is also possible.

Other texturizing methods may also be employed according to the invention, such as heat treatment in a gas (for example O₂ or N₂ in the case of a substrate based on SiC). Plasma etching or chemical etching processes may also be used to obtain the texturizing according to the invention, depending on the operating conditions and on the nature of the substrate.

Within the meaning of the present invention, the term “catalytic coating” is defined as a coating comprising or formed by a material known for catalyzing the reaction of transforming the gaseous pollutants, i.e. mainly carbon monoxide (CO), unburnt hydrocarbons and nitrogen oxides (NOₓ), into less harmful gases such as gaseous nitrogen (N₂) or carbon dioxide (CO₂), and/or for facilitating the combustion of the soot particles stored on the filter.

This coating, as is well known, usually includes an inorganic support material of high specific surface area (typically of the order of 10 to 100 m²/g) ensuring that an active phase, such as metals, in general noble metals, which act as the actual catalysis center of the oxidation or reduction reactions, is dispersed and stabilized. The support material is typically based on oxides, more particularly on alumina or silica, or on other oxides, for example based on ceria, zirconia or titania, or even mixed blends of these various oxides. The size of the particles of support material constituting the catalytic coating on which the catalytic metal particles are placed is of the order of a few nanometers to a few tens of nanometers, or exceptionally a few hundred nanometers.

The catalytic coating is typically obtained by impregnation with a solution comprising the catalyst in the form of the support material or its precursors and of an active phase or a precursor of the active phase. In general, the precursors used take the form of organic or mineral salts or compounds, dissolved or in suspension in an aqueous or organic solution. The impregnation is followed by a heat treatment for the purpose of obtaining the final coating of a solid and catalytically active phase in the pores of the filter.

Such processes, and the devices for implementing them, are for example described in the patent applications or patents US 2003/044520, WO 2004/091786, U.S. Pat. No. 6,149,973, U.S. Pat. No. 6,627,257, U.S. Pat. No. 6,478,874, U.S. Pat. No. 5,866,210, U.S. Pat. No. 4,609,563, U.S. Pat. No. 4,550,034, U.S. Pat. No. 6,599,570, U.S. Pat. No. 4,208,454 or U.S. Pat. No. 5,422,138.

Whatever the method used, the cost of the catalysts deposited, which usually contain precious metals of the platinum group (Pt, Pd, Rh) as active phase on an oxide support, represents a not inconsiderable part of the overall cost of the impregnation process. For the sake of economy, it is therefore important for the catalyst to be deposited as uniformly as possible, so as to be easily accessible by the gaseous reactants.

A filter according to the invention, and as described above, may typically be used in an exhaust line of a diesel or gasoline engine.

The invention and its advantages will be better understood on reading the following exemplary embodiments, which do not limit the present invention and are provided exclusively as illustration.

### EXAMPLE 1

### Comparative Example

In this example, an SiC-based catalytic filter was synthesized in the manner normally used.

More precisely, firstly 70% by weight of an SiC powder having grains with a median diameter d₅₀ of 10 microns was blended with a second SiC powder having grains with a median diameter d₅₀ of 0.5 microns in a first embodiment comparable to the powder blend described in EP 1 142 619. Within the context of the present description, the term “median pore diameter d₅₀” denotes the diameter of the particles such that respectively 50% of the total population of the grains has a size smaller than this diameter. Added to this blend was a pore former of the polyethylene type in a proportion equal to 5% by weight of the total weight of the SiC grains and a forming additive of the methylcellulose type in a proportion equal to 10% by weight of the total weight of the SiC grains, as indicated in Table 2.

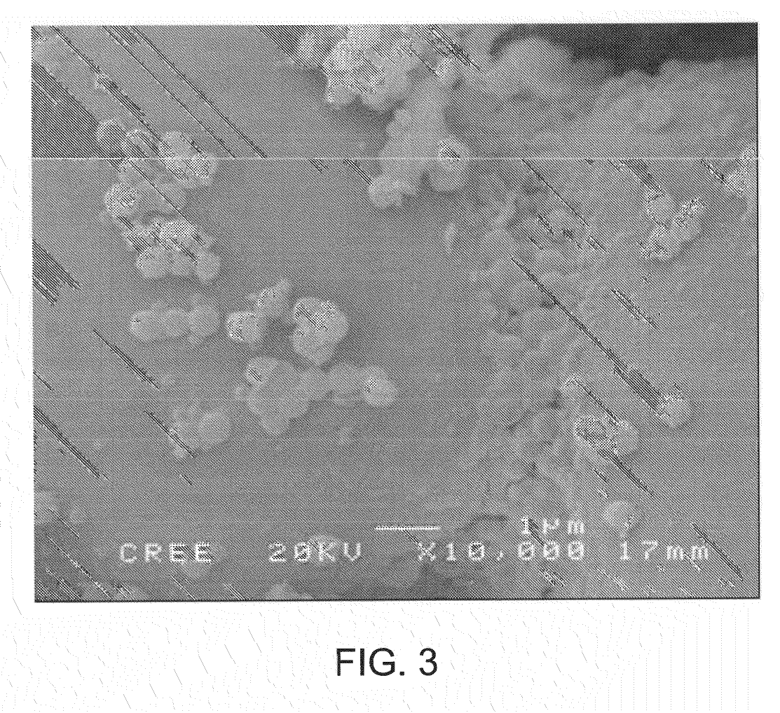

Next, the necessary amount of water was added and mixing was carried out until a homogeneous paste was obtained that had a plasticity enabling it to be extruded through a die having a honeycomb structure so as to produce monoliths characterized by a wavy arrangement of the internal channels such that those described in relation to FIG. 3 of application WO 05/016491 are obtained. In cross section, the waviness of the walls is characterized by an asymmetry factor, as defined in WO 05/016491, equal to 7%.

The dimensional characteristics of the structure after extrusion are given in Table 1:

TABLE 1

| Channel and monolith geometry | Wavy | |
|---|---|---|
| Channel density | 180 cpsi (channels per square | |
| | inch, 1 inch = 2.54 cm), | |
| | i.e. 27.9 channels/cm² | |
| Internal wall thickness | 300 | μm |
| Mean external wall thickness | 600 | μm |
| Length | 17.4 | cm |
| Width | 3.6 | cm |

Next, the green monoliths obtained were dried by microwave drying for a time sufficient to bring the content of water not chemically bound to less than 1% by weight.

The channels of each face of the monoliths were alternately blocked using well-known techniques, for example those described in application WO 2004/065088.

The monoliths were then fired in argon with a temperature rise of 20° C./hour until a maximum temperature of 2200° C. was reached, this being maintained for 6 hours.

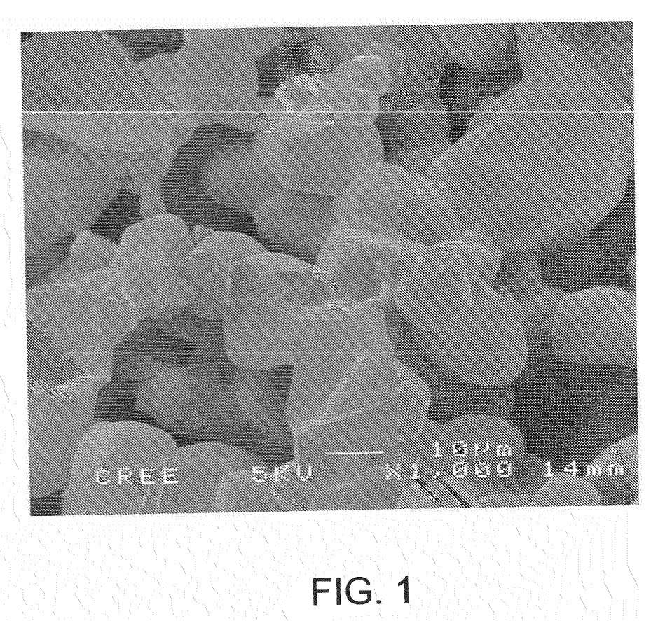

Thus, an uncoated SiC filtering structure was obtained. FIG. 1 shows an SEM (scanning electron microscope) micrograph of the filtering walls of the filter thus obtained, these being formed by a matrix of SiC grains of smooth surface interconnected by grain boundaries, the porosity of the material being provided by the cavities left between the grains.

### EXAMPLE 2

### According to the Invention

In this example, the uncoated structure obtained according to example 1 was then subjected to a first texturizing treatment, the material used for the texturizing being introduced into the pores of the filter in the form of a slip.

More precisely, an SiC-based suspension in the form of a slip was used.

The suspension comprised, in percentages by weight, 96% of water, 0.1% of dispersant of the nonionic type, 1.0% of a binder of the PVA (polyvinyl alcohol) type and 2.8% of an SiC powder with a median diameter of 0.5 μm, the purity of which was greater than 98% by weight.

The slip or suspension was prepared according to the following steps:
the PVA, used as binder, was firstly dissolved in water heated to 80° C. The dispersant and then the SiC powder were introduced into a tank containing the PVA dissolved in water and kept stirred until a homogeneous suspension was obtained.

The slip was deposited into the filter by simple immersion, the excess suspension being removed by vacuum suction under a residual pressure of 10 mbar.

The filter thus obtained underwent a drying step at 120° C. for 16 hours followed by a sintering heat treatment at 1700° C. in argon for 3 hours.

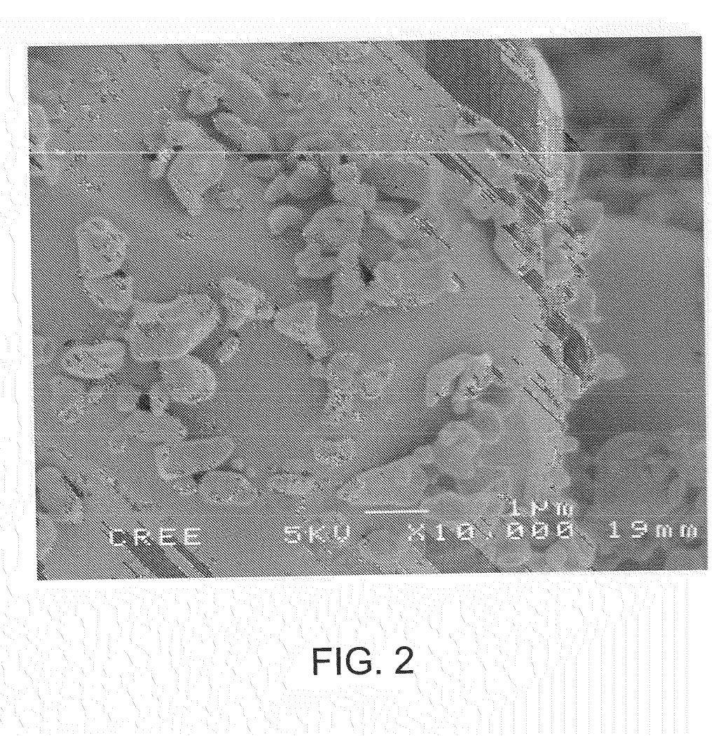

FIG. 2 shows an SEM micrograph of the filtering walls of the textured filter thus obtained, showing the irregularities on the surface of the SiC grains constituting the porous matrix, in this example taking the form of SiC crystallites and SiC crystallite clusters.

According to this embodiment, the measured parameter d corresponds to the mean diameter, as described above, of the crystallites present on the surface of the SiC grains. The parameter h corresponds to the mean height h of said crystallites.

### EXAMPLE 3

### According to the Invention

In this example, the uncoated structure obtained according to example 1 was subjected to another texturizing treatment, the material serving for the texturizing being introduced into the pores of the filter in the form of a silica sol containing an inorganic filler.

More precisely, a silica sol filled with alumina particles was used.

The sol comprised, in percentages by weight, 45.6% of water, 34.7% of an aqueous solution containing 10.5% by weight of alumina particles sold by Nissan under the reference Chemical Aluminasol 200® or 1.7% of TEOS (tetraethoxysilane), 17.0% of 2-propanol and 1.0% of a 37% hydrochloric acid solution.

The sol filled with inorganic particles was prepared according to the following steps:

In a first step, the TEOS in 2-propanol was hydrolyzed in the presence of the hydrochloric acid solution so as to form the sol. In a second step, the filler was added by means of the aqueous solution containing the alumina particles, the third step consisting of a dilution in water. The filled sol-gel was then left to rest for 18 hours before the next step. After maturization, the solution was then deposited in the monolith by simple immersion, the excess being removed by vacuum suction under a residual pressure of 10 mbar.

The monolith thus obtained was then dried at 150° C. for 1 hour and then subjected to a heat treatment of 250° C. in air for 1 hour.

The textured monolith thus obtained showed irregularities on the surface of the SiC grains constituting the porous matrix, in this example taking the form of rods fixed to the surface of the SiC grains and/or to the grain boundaries. As described above, the irregularities had, on the surface of the grains, a mean height h=2 μm and a mean diameter d=1 μm.

### EXAMPLE 4

### According to the Invention

In this example, the uncoated structure obtained according to example 1 was subjected to another texturizing treatment, the material serving for the texturizing being introduced into the pores of the filter in the form of a silica sol comprising an inorganic filler according to the same principles as those described in example 2. Unlike example 3, this time a silica sol filled with silica microbeads was used.

The sol comprised,in percentages by weight, 45% of an aqueous colloidal solution of silica beads with a diameter of between 300 and 400 nm, the concentration by weight of beads being about 40%, in the form sold under the reference MP4540 Nyacol®, 3.3% of TEOS (tetraethoxysilane), 32.4% of 2-propanol used for preparing the sol, 17.3% of 2-propanol used as diluent and 2.0% of a 37% hydrochloric acid solution.

The sol filled with inorganic particles was prepared according to the following steps:

In a first step, the TEOS in 2-propanol was hydrolyzed in the presence of the hydrochloric acid solution in order to form the sol. In a second step, the filler was added by means of the aqueous colloidal solution containing the silica beads, the third step consisting of a dilution in 2-propanol. The filled sol-gel was then left to rest for 18 hours before the next step. After maturization, the solution was then deposited in the monolith by simple immersion, the excess being removed by vacuum suction under a residual pressure of 10 mbar.

The monolith thus obtained was then dried at 150° C. for 1 hour and then subjected to a heat treatment of 250° C. in air for 1 hour.

FIG. 3 shows an SEM micrograph of the filtering walls of the textured monolith thus obtained, showing the irregularities on the surface of the SiC grains constituting the porous matrix, in this example taking the form of silica beads encapsulated in an envelope obtained by sintering the silica sol and causing the SiC grains constituting the matrix to be joined together and bonded.

The texturizing according to this embodiment is formed from juxtaposed or isolated spherical beads, characterized by their mean diameter that corresponds, according to the above definitions, to the h and d values according to the invention.

### EXAMPLE 5

### According to the Invention

In this example, the uncoated structure obtained according to example 1 was subjected to another texturizing treatment, the material serving for the texturizing being introduced into the pores of the monolith in the form of a silica sol containing an organic filler.

The sol comprised, in percentages by weight, 4% of polymethyl methacrylate beads approximately 2 μm in diameter, sold by SEPPIC under the reference Micropearl M-201®, 16.3% of TEOS (tetraethoxysilane), 72.3% of ethanol and 7.4% of a 4.4 wt % aqueous HCl solution.

The sol filled with inorganic particles was prepared according to the following steps:

The organic filler consisting of polymethyl methacrylate beads was firstly mixed with the ethanol. The TEOS was then progressively added, with stirring. The aqueous solution containing HCl was then progressively added, with vigorous stirring, so as to allow the TEOS to be progressively and homogeneously hydrolyzed and to obtain the gel.

The sol-gel was then deposited in the monolith by simple immersion, the excess being removed by vacuum suction under a residual pressure of 10 mbar.

The monolith thus obtained was then dried at 110° C. for 16 hours and then subjected to a heat treatment of 550° C. in air for 5 hours.

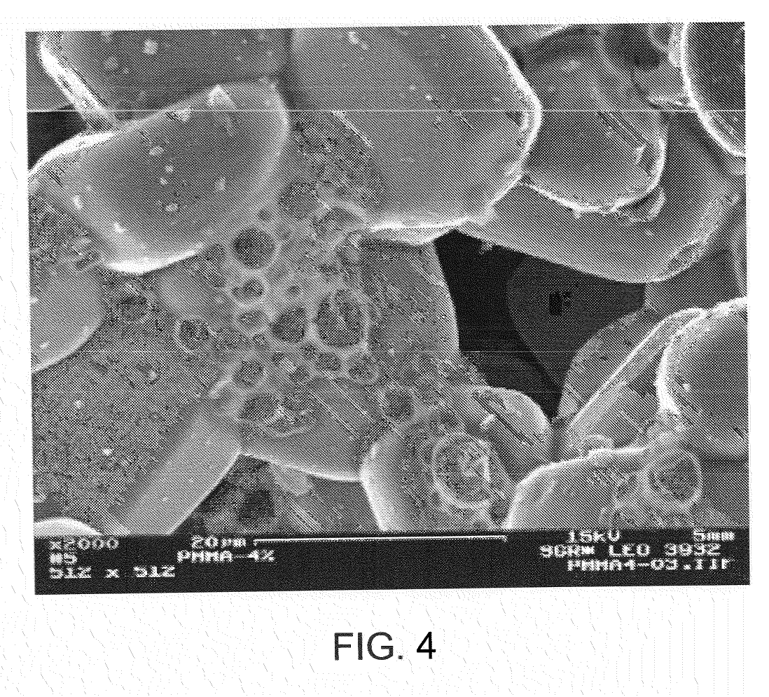

FIG. 4 shows an SEM micrograph of the filtering walls of the textured monolith thus obtained, showing the irregularities on the surface of the SiC grains constituting the porous matrix. As may be seen in FIG. 4, the irregularities according to this example this time take the form of hollows or craters present within the texturizing material consisting of silica (SiO₂), obtained by sintering the silica sol, after the heat treatment and the removal of the organics.

According to this embodiment, the measured parameter d corresponds to the mean diameter, as described above, of the craters hollowed out by removal of the organic spheres within the SiO₂ texturizing layer on the surface of the SiC grains. The mean depth p of said craters was 2 μm.

### EXAMPLE 6

### According to the Invention

In this example, the uncoated structure obtained according to example 1 was subjected to another texturizing treatment, the material serving for the texturizing being introduced into the pores of the monolith in the form of a silica sol containing an organic filler different from that of example 5.

The sol comprised, in percentages by weight, 2% of latex beads with a diameter of 120 nm, 16.3% of TEOS (tetraethoxysilane) and 81.7% of a 0.38 wt% aqueous HCl solution.

The sol filled with inorganic particles was prepared by firstly blending the latex beads with the aqueous HCl solution and then by progressively adding the TEOS with vigorous stirring so as to homogeneously hydrolyze the silicate and to obtain a gel.

The sol-gel was then deposited in the monolith by simple immersion, the excess being removed by vacuum suction under a residual pressure of 10 mbar.

The monolith thus obtained was then dried at 110° C. for 16 hours and then subjected to a heat treatment of 550° C. in air for 5 hours.

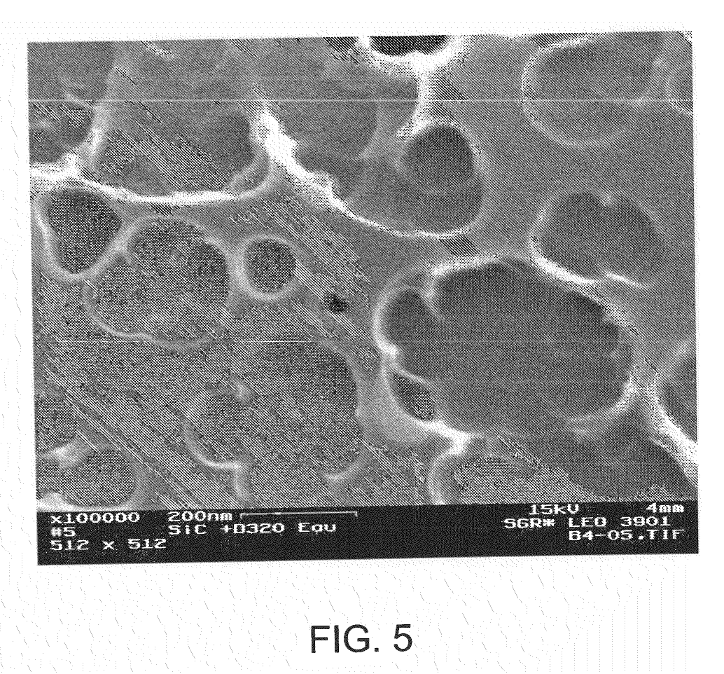

FIG. 5 shows an SEM micrograph of the filtering walls of the textured monolith thus obtained, showing the irregularities covering the surface of the SiC grains constituting the porous matrix. As may be seen in FIG. 5, according to this example the irregularities this time take the form of hollows or craters present within the texturizing material formed by a silica (SiO₂) coating, obtained by sintering the silica sol, after the heat treatment and the removal of the organics.

According to this embodiment, the measured parameter d corresponds to the mean diameter, as described above, of the craters hollowed out by removal of the organic spheres within the SiO₂ texturizing layer on the surface of the SiC grains. The parameter p corresponds to the mean depth p of said craters.

The properties of these microtextured monoliths of examples 2 to 6 according to the invention were measured and compared with those of the untextured reference monolith of example 1.

Since the drying and the various heat treatments carried out during the texturizing process do not affect the structure of the reference monoliths, it is possible for the results of the measurements carried out on the monoliths according to the invention to be compared directly with those of the reference monolith. These properties were measured according to the following experimental protocols:

A: Weight uptake during the texturizing deposition after heat treatment:

The weight uptake associated with the deposition of the texturizing material was measured on each monolith after heat treatment and related to the weight of the reference monolith.

B: Measurement of the porosity of the material constituting the matrix:

The open porosity of the material constituting the walls of the monoliths according to examples 1 to 6 was determined using the conventional high-pressure mercury porosimetry techniques with a Micromeritics 9500 porosimeter.

C: Measurement of the geometric characteristics of the irregularities of the texturizing coating:

The parameters d, h or p as defined above, characterizing the irregularities present on the surface of the SiC grains, were measured on a series of scanning electron microscope observations, on a series of images representative of the coating deposited and at various points on the monolith.

These images, from which the appended FIGS. 1 to 5 are extracted, correspond to characteristic views of the internal structure, in particular of the open porosity, of the walls of channels fractured in the transverse direction, within the monolith.

Other SEM observations, carried out on a series of micrographs at different points on the monolith, also enabled the surface area covered by the texturizing material to be measured relative to the total surface area of the grains and grain boundaries of the inorganic material constituting the porous matrix.

D: Measurement of the quantity of catalytic coating (or washcoat) after impregnation:

The monoliths according to the invention (examples 2 to 6) and the reference monolith (example 1) were subjected to an impregnation treatment with a catalytic solution representative of the solutions currently used, according to the following experimental protocol:

The monolith was immersed in a bath of an aqueous solution containing the appropriate proportions of a platinum precursor in the H₂PtCl₆ form and of a cerium oxide (CeO₂) precursor (in the form of cerium nitrate) and of a zirconium oxide (ZrO₂) precursor (in the form of zirconyl nitrate) according to the principles described in the publication EP 1 338 322 A1. The monolith was impregnated with the solution using a method of implementation similar to that described in the U.S. Pat. No. 5,866,210. The monolith was then dried at about 150° C. and then heated to a temperature of about 500° C.

E: Measurement of the pressure drop:

The pressure drop of the monoliths obtained after the catalytic impregnation described above (see point D above) was measured using the techniques of the art in a stream of ambient air, having an airflow rate of 30 m³/h. The term “pressure drop” is understood within the meaning of the present invention to be the differential pressure existing between the upstream side and the downstream side of the monolith.

F: Light-off catalytic efficiency test:

This test was intended to measure the light-off temperature of the catalyst. This temperature is defined, under constant gas pressure and flow rate conditions, as the temperature for which a catalyst converts 50% by volume of the pollutant gases. The CO and HC conversion temperature was determined here using an experimental protocol identical to that described in application EP 1 759 763, especially in paragraphs 33 and 34 thereof. According to the measurement, the lower the conversion temperature, the more efficient the catalytic system.

The test was carried out on specimens measuring about 25 cm³ cut from a monolith.

G: Post-aging light-off catalytic efficiency test.

An unmicrotextured fired monolith and a textured monolith according to each example of the invention were pre-impregnated with catalyst as described in paragraph D and then placed in a furnace at 800° C. in wet air for a duration of 5 hours such that the molar concentration of water was kept constant at 3%.

The degree of CO conversion at 420° C. and the HC light-off temperature were measured on each monolith specimen thus aged, using the same experimental protocol as that described in point F above. The increase in HC light-off temperature was calculated from the difference between the HC light-off temperature on an aged specimen and that measured on an unaged specimen. According to these tests, the lower the light-off temperature on an aged specimen or the smaller the increase in light-off temperature due to aging, the greater the aging resistance of the catalytic system. The higher the post-aging degree of conversion, the more efficient the catalytic system.

The main results obtained for the various measurements A to F above are collated in Table 2:

TABLE 2

| | Example | | | | | |
|---|---|---|---|---|---|---|
| | 1 (Ref.) | 2 | 3 | 4 | 5 | 6 |
| A: Weight uptake | — | 3.4 | 1.2 | 5.1 | 2.1 | 1.4 |
| (wt %) | | | | | | |
| B: Porosity (%) | 48.0 | 47.3 | 48.2 | 48.0 | 47.5 | 47.8 |
| C: p (μm) | — | — | — | — | 2 | 0.15 |
| h (μm) | — | 0.5 | 1 | 0.3 to 0.4 | — | — |
| d (μm) | — | 0.5 | 2 | 0.3 to 0.4 | 2 | 0.30 |
| % area covered | — | 18 | 60 | 40 | 25 | 25 |
| D: Amount of | 185 | 200 | 199 | 178 | 225 | 172 |
| washcoat deposited | | | | | | |
| on the filter | | | | | | |
| (g/l of filter) | | | | | | |
| E: Pressure drop | 21.2 | 21.1 | 22.3 | 22.2 | 22.0 | 21.6 |
| (mbar) | | | | | | |
| F: Light-off test: | | | | | | |
| a) Temperature | 275 | 265 | 255 | 230 | 260 | 245 |
| (° C.) for converting | | | | | | |
| 50% of the CO of | | | | | | |
| the gas mixture | | | | | | |
| b) Temperature | 282 | 275 | 260 | 250 | 265 | 252 |
| (° C.) for converting | | | | | | |
| 50% of the HC of | | | | | | |
| the gas mixture | | | | | | |
| G: Light-off on aged | | | | | | |
| specimens: | | | | | | |
| a) Degree of | 10 | 16 | 15 | 20 | 15 | 13 |
| conversion (in %) of | | | | | | |
| the CO of the gas | | | | | | |
| mixture at 420° C. | | | | | | |
| b) Temperature | 400 | 391 | 392 | 385 | 395 | 390 |
| (° C.) for converting | | | | | | |
| 50% of the HC of | | | | | | |
| the gas mixture | | | | | | |
| c) Increase in the | 118 | 116 | 132 | 135 | 130 | 139 |
| HC 50% conversion | | | | | | |
| temperature | | | | | | |

The monoliths of examples 2, 3 and 5 show a substantially higher level of catalytic coating (washcoat) than that of the reference (example 1), for equivalent porosity characteristics. It should be noted that the pressure drop caused by the monoliths according to the invention is also hardly affected by the significant increase in the amount of catalyst present in the textured filters according to the invention. Thus, the measured pressure drop values remain very acceptable for the filtering application.

All the monoliths of the invention show a more effective catalytic activity than the reference.

Those of examples 4 and 6 show a very much greater catalytic efficiency despite an appreciably lower amount of catalyst than the reference (example 1), which could be interpreted as the result of better distribution of the catalyst or else easier access to the active sites for the gases to be purified.

The monolith of example 2 shows a high loading of washcoat and a high catalytic efficiency despite a low percentage area of microtextured surface, thereby demonstrating a very substantial effect of the microtexturizing even if this is present only over a minimal part of the surface of the grains.

All the products of the invention show a higher catalytic performance after aging than the reference. In particular, examples 4 and 6 show the best aging resistance values despite the lowest washcoat loadings. Example 2 shows the lowest increase in HC light-off temperature.

Furthermore, the products according to the invention retain all their mechanical strength properties, while still maintaining their filtration efficiency, unlike the solutions known hitherto for increasing the loading of catalyst present in the pores of the filtering structures, especially by increasing the size of the pores (open porosity, pore diameter).

1. A catalytic filter for the treatment of solid particles and gaseous pollutants contained in the combustion gases of an internal combustion engine, said filter comprising a porous matrix consisting of an inorganic material, in the form of grains that are interconnected so as to provide cavities between them, to the extent that the open porosity is between 30 and 60% and the median pore diameter is between 5 and 40 μm, wherein:
the grains and optionally the grain boundaries of the inorganic material are covered over at least part of their surface with a texturizing material, said texturizing consisting of irregularities having dimensions of between 10 nm and 5 microns; and
the texturizing material and optionally, at least partially, the grains of the inorganic material are coated at least partially by a catalytic coating.

2. The filter as claimed in claim 1, in which said texturizing consists of irregularities taking the form of beads, crystallites, polycrystalline clusters, rods or acicular structures, hollows or craters, said irregularities having a mean equivalent diameter d of between about 10 nm and about 5 microns and a mean height h or a mean depth p of between about 10 nm and about 5 microns.

3. The filter as claimed in claim 2, in which the mean diameter d of the irregularities is between 100 nm and 2.5 microns.

4. The filter as claimed in claim 2, in which the mean height h or the mean depth p of the irregularities is between 100 nm and 2.5 microns.

5. The filter as claimed in claim 1, in which the texturizing material covers at least 10% of the total surface of the grains and optionally of the grain boundaries of the inorganic material constituting the porous matrix.

6. The filter as claimed in claim 2, in which the mean equivalent diameter d and/or the mean height h or the mean depth p of the irregularities are/is smaller than the mean size of the grains of the inorganic material constituting the matrix by a factor of between ½ and 1/1000.

7. The filter as claimed in claim 2, in which the mean equivalent diameter d and/or the mean height h or the mean depth p of the irregularities are/is smaller than the mean size of the grains of the inorganic material constituting the matrix by a factor of between ⅕ and 1/100.

8. The filter as claimed in claim 1, in which the texturizing material is of the same nature as the inorganic material constituting the matrix.

9. The filter as claimed in claim 1, in which the irregularities are formed by crystallites or by a cluster of crystallites of a fired or sintered material on the surface of the grains of the porous matrix.

10. The filter as claimed in claim 1, in which the irregularities essentially consist of alumina or silica beads.

11. The filter as claimed in claim 1, in which the irregularities take the form of craters hollowed out in a silica or alumina material, said material being fired or sintered on the surface of the grains of the porous matrix.

12. The filter as claimed in claim 1, in which the material constituting the matrix is formed by or comprises silicon carbide.

13. An intermediate structure for obtaining a catalytic filter for the treatment of solid particles and gaseous pollutants as claimed in claim 1, comprising a porous matrix consisting of an inorganic material, in the form of grains that are interconnected so as to provide cavities between them, to the extent that the open porosity is between 30 and 60% and the median pore diameter is between 5 and 40 μm, said grains of the inorganic material being covered over at least part of their surface with a texturizing material.

14. A process for obtaining a filter as claimed in claim 1, comprising:
forming and firing a honeycomb structure consisting of a porous matrix of an inorganic material, in the form of grains that are interconnected so as to provide cavities between them, to the extent that the open porosity is between 30 and 60% and the median pore diameter is between 5 and 40 μm;
depositing on the surface of at least some of the grains of the honeycomb structure, a texturizing material having the form of beads, crystallites, polycrystalline clusters, hollows or craters; and
impregnating the textured honeycomb structure with a solution comprising a catalyst or a catalyst precursor.

15. The process as claimed in claim 14, in which the texturizing material is deposited by the application of a slip of said material for covering the surface of the grains, followed by a firing or sintering heat treatment.

16. The process as claimed in claim 14, in which the texturizing material is deposited by the application of a sol-gel solution that includes a filler in the form of inorganic beads or particles, followed by a firing or sintering heat treatment.

17. The process as claimed in claim 14, in which the texturizing material is deposited by the application of a sol-gel solution that includes a filler in the form of organic beads or particles, followed by a firing or sintering heat treatment.

18. The process as claimed in claim 16, in which the sol-gel solution is a silica sol.

19. (canceled)

20. The process as claimed in claim 17, in which the sol-gel solution is a silica sol.

21. An exhaust line of a diesel or gasoline engine comprising the filter as claimed in claim 1.
